(19) United States
(12) Patent Application Publication
(10) Pub. No.: US 2010/0067047 A1
(43) Pub. Date: Mar. 18, 2010

(54) DISPLAY CONTROL APPARATUS, IMAGE FORMING APPARATUS, AND COMPUTER-READABLE MEDIUM STORING DISPLAY CONTROL PROGRAM

(75) Inventors: Takanori Miyamoto, Osaka-shi (JP); Yoshifumi Okabayashi, Osaka-shi (JP); Dai Shigenobu, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/557,881

(22) Filed: Sep. 11, 2009

(30) Foreign Application Priority Data
Sep. 12, 2008 (JP) 2008-235427

(51) Int. Cl. G06F 15/00; G09G 5/00

(52) U.S. Cl. 358/1.15; 345/156

(57) ABSTRACT

A display control apparatus includes: a display unit that displays an image; a web browser that causes the display unit to display thereon a web page; an operation state detection unit that detects an operation state of an image forming apparatus; and a panel application that causes the display unit to display in a status area thereof an operation state detected by the operation state detection unit. The web browser causes the display unit to display in an area outside the status area thereof the web page.

### BACKGROUND OF THE INVENTION

1. Field of the Invention

The present invention relates to a display control apparatus, an image forming apparatus, a display control program, and a computer-readable medium which stores the display control program, and more particularly to a technology for displaying a web page and an operation state of electric equipment on a display unit.

2. Description of the Background Art

Conventional image forming apparatuses, such as copiers, multifunction machines (devices that combine a copier function, a printer function, a fax function and a scanner function) and the like are provided with display units that comprise, for instance, an LCD (Liquid Crystal Display), in order to display operation guidance to the user. It has been proposed to connect image forming apparatuses to the internet, and to allow displaying internet web pages on the above-mentioned display unit, in addition to the display of operation guidance.

### SUMMARY OF THE INVENTION

The present invention makes further improvements on the above-described conventional technology.

Specifically, the present invention is a display control apparatus including: a display unit that displays an image; a web browser function unit that causes the display unit to display a web page; an operation state detection unit that detects an operation state of electric equipment to which the display control apparatus is provided; and a state display control unit that causes the display unit to display in a status area thereof which is determined as a display area of the operation state an operation state detected by the operation state detection unit, wherein the web browser function unit causes the display unit to display in an area thereof outside a status area the web page.

These and other objects, features and advantages of the present invention will become more apparent upon reading of the following detailed description along with the accompanied drawings.

### BRIEF DESCRIPTION OF THE DRAWINGS

FIG. 1 is a side-view schematic diagram illustrating the configuration of a multifunction machine as an embodiment of an image forming apparatus comprising a display control device according to the present invention;

FIG. 2 is a control block diagram of the multifunction machine;

FIG. 3 is a diagram illustrating schematically the configuration of a control unit of the multifunction machine;

FIG. 4 is a flowchart illustrating display control of the display unit in the multifunction machine;

FIG. 5 is a diagram illustrating an example of an initial operation screen;

FIG. 6 is a diagram illustrating an example of a screen depicting a copy operation in progress;

FIG. 7 is a diagram illustrating an example of a web page display screen;

FIG. 8 is a flowchart illustrating a first embodiment of a process for displaying an operation state of the multifunction machine in a status area;

FIG. 9 is a diagram illustrating an example of an initial operation screen;

FIG. 10 is a diagram illustrating an example of a copy operation in-progress screen;

FIG. 11 is a diagram illustrating an example of a web page display screen;

FIG. 12 is a diagram illustrating an example of a web page display screen;

FIG. 13 is a flowchart illustrating a second embodiment of a process for displaying an operation state of the multifunction machine in a status area; and

FIG. 14 is a flowchart illustrating a third embodiment of a process for displaying an operation state of the multifunction machine in a status area.

### DETAILED DESCRIPTION OF THE PREFERRED EMBODIMENTS

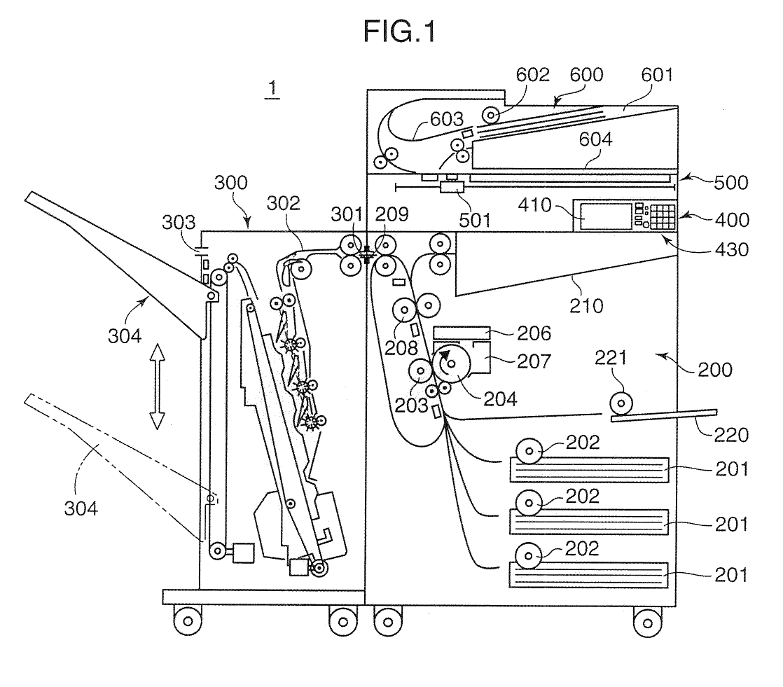

An embodiment of an image forming apparatus comprising a display control device according to the present invention will be explained below. FIG. 1 is a side-view schematic diagram illustrating the configuration of a multifunction machine as an embodiment of an image forming apparatus comprising a display control device according to the present invention.

A multifunction machine 1 comprises a main body 200; a paper post-processing unit 300 arranged on the paper carry-out side of the main body 200, for instance on the left side; an operation unit 400 through which, for instance, various operation commands are inputted by a user; a document reading unit 500 disposed above the main body 200; and a document feeding unit 600 disposed above the document reading unit 500.

The operation unit 400 comprises a display unit (display means) 410 comprising, for instance, an LCD (Liquid Crystal Display), and an operation key unit 430 through which an operator inputs operation instructions. The operation key unit 430 comprises, for instance, a start key and a numerical keypad.

The document feeding unit 600 comprises a document placing section 601, a paper feeding roller 602, a document transport unit 603 and a document discharge unit 604. The document reading unit 500 comprises a scanner 501. The paper feeding roller 602 pays out, one by one, a required number of documents set in the document placing section 601. The document transport unit 603 sequentially transports the paid out documents up to a reading position of the scanner 501. The scanner 501 reads sequentially the images of the transported documents, whereupon the read documents are discharged at the document discharge unit 604.

The main body 200 comprises, for instance, a plurality of paper feeding cassettes 201, a plurality of paper feeding rollers 202, a transfer roller 203, a photosensitive drum 204, an exposure device 206, a developing device 207, fixing rollers 208, a discharge port 209 and a discharge tray 210.

The photosensitive drum 204 charges uniformly a charging device (not shown) while rotating in the direction of the arrow. The exposure device 206 scans laser light, modulated in accordance with image data of the document read by the document reading unit 500, onto the photosensitive drum 204, to form an electrostatic latent image on the drum surface. The developing device 207 supplies black developer to the photosensitive drum 204, to form thereby a toner image.

Meanwhile, the paper feeding rollers 202 draw printing paper out of the paper feeding cassettes 201 in which printing paper is stored, and feed the printing paper up to the transfer roller 203. The transfer roller 203 transfers the toner image on the photosensitive drum 204 onto the transported printing paper. The fixing rollers 208 heat the transferred toner image, to fix the latter onto the printing paper. Thereafter, the printing paper is conveyed through the discharge port 209 of the main body 200 into the paper post-processing unit 300. Optionally, the printing paper may also be discharged onto the discharge tray 210.

The paper post-processing unit 300 comprises, for instance, an inlet port 301, a printing paper transport unit 302, an outlet port 303 and a stack tray 304. The printing paper transport unit 302 sequentially transports printing paper conveyed in through the inlet port 301, out of the discharge port 209, and discharges eventually the printing paper onto the stack tray 304 through the outlet port 303. The stack tray 304 is configured to be vertically movable, in the direction of the arrows, in accordance with the number of stacked printing paper sheets conveyed out through the outlet port 303.

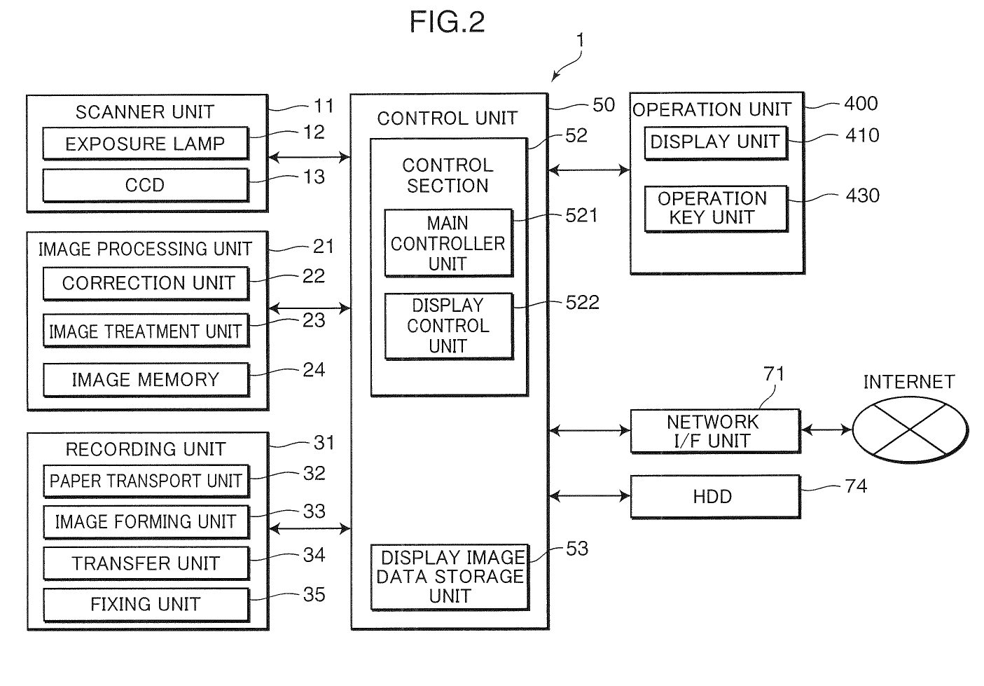

FIG. 2 is a control block diagram of the multifunction machine 1. This multifunction machine 1 comprises a scanner unit 11, an image processing unit 21, a recording unit 31, an operation unit 400, a control unit 50, a network I/F (interface) unit 71 and an HDD (hard disk drive) 74.

The scanner unit 11 comprises an exposure lamp 12 and a CCD (Charge Coupled Device) 13 that make up the scanner 501 in FIG. 1. The exposure lamp 12 irradiates the document and the CCD 13 receives the resulting reflected light, whereby the scanner unit 11 reads an image from the document. The scanner unit 11 outputs image data corresponding to the read image to the image processing unit 21.

The image processing unit 21 comprises a correction unit 22, an image treatment unit 23 and an image memory 24. The image processing unit 21 processes the read image data as necessary, by way of the correction unit 22 and the image treatment unit 23, stores the processed image data in the image memory 24 and outputs the image data to the recording unit 31. The correction unit 22 performs predetermined corrections, such as level correction and γ correction, on the read image data. The image treatment unit 23 performs various treatments on the image data, for instance compression/expansion or enlargement/reduction.

The recording unit 31 comprises a paper transport unit 32 comprising, for instance, the paper feeding cassettes 201 and the paper feeding rollers 202 illustrated in FIG. 1; an image forming unit 33 comprising, for instance, the photosensitive drum 204, the exposure device 206 and the developing device 207 illustrated in FIG. 1; a transfer unit 34 comprising, for instance, the transfer roller 203 illustrated in FIG. 1; and a fixing unit 35 comprising, for instance, the fixing rollers 208 illustrated in FIG. 1. The recording unit 31 prints image data on recording paper using document data read by the scanner unit 11. Specifically, the paper transport unit 32 transports the recording paper to the image forming unit 33, the image forming unit 33 forms a toner image corresponding to the image data, the transfer unit 34 transfers the toner image onto the recording paper, and the fixing unit 35 fixes the toner image onto the recording paper to form thereby an image.

The network I/F unit 71 uses a network interface or the like to control exchange of various data with external devices, and provides also an internet connection, by way of Ethernet™ or the like via an LAN (Local Area Network). The HDD 74 stores image data read by the scanner unit 11, as well as output formats and the like that are set for the image data.

The operation unit 400 comprises the display unit 410 and the operation key unit 430 illustrated in FIG. 1. The display unit 410 comprises, for instance, a touch panel unit that combines a touch panel and an LCD. The display unit 410 displays various operation images and enables the user to input execution commands for various functions by touching the display surface (display operation keys). As described above, the operation key unit 430 comprises, for instance, a start key and a numerical keypad.

The control unit 50 comprises a control section 52 and a display image data storage unit 53.

The control section 52 comprises a main controller unit 521 and a display control unit 522. The main controller unit 521 governs the control of the operation of the multifunction machine 1. The display control unit 522 performs display control for displaying to the user, on the display unit 410, for instance guidance information on the operation of the multifunction machine 1, operation states of the working mechanisms of the various units in the multifunction machine 1, as well as web pages or the like. The display image data storage unit 53 stores various image data to be displayed on the display unit 410. The various image data stored in the display image data storage unit 53 include images corresponding to operation states and operation guidance information in order to display, to the user, respective operation guidance information on the multifunction machine 1, and operation states of the various operation mechanisms of the units of the multifunction machine 1.

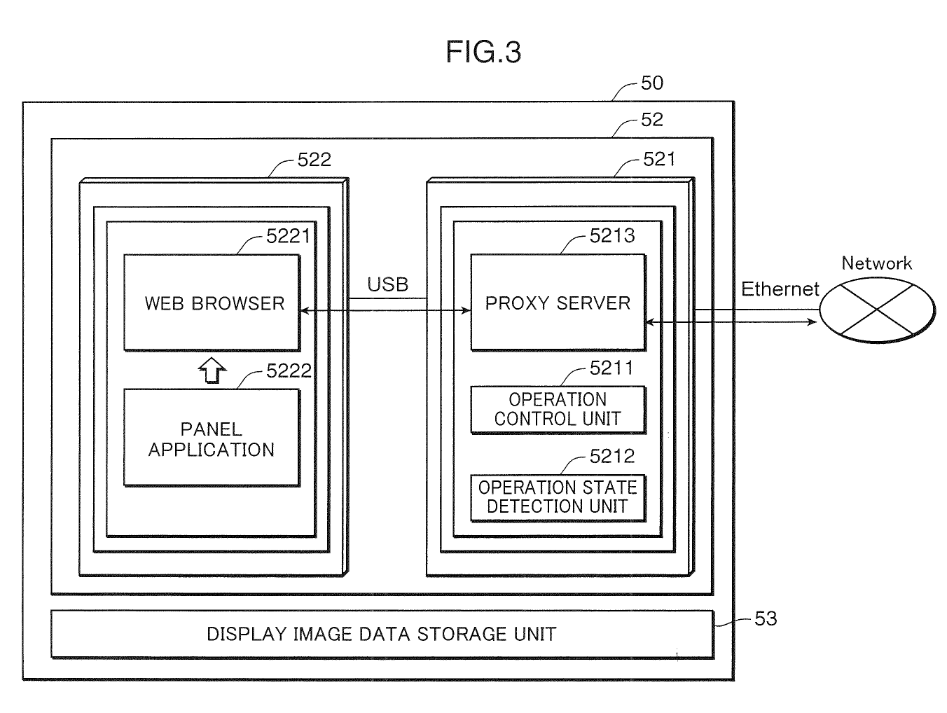

FIG. 3 is a diagram illustrating schematically the configuration of the control unit 50 of the multifunction machine 1. As described above, the control unit 50 comprises the main controller unit 521 and the display control unit 522. The main controller unit 521 comprises for instance a CPU. The display control unit 522 comprises for instance an ASIC (Application Specific Integrated Circuit). The boards that make up the foregoing are connected by way of, for instance, an USB (Universal Serial Bus).

The main controller unit 521 comprises an operation control unit 5211, an operation state detection unit 5212 and a proxy server 5213.

The operation control unit 5211 governs the control of the operation of the various units of the multifunction machine 1 (scanner unit 11, image processing unit 21, recording unit 31 and so forth).

The operation state detection unit 5212 detects the operation state of the various mechanisms of the multifunction machine 1 on the basis of the job process status as per the operation control unit 5211, and on the basis of signals sent by the various mechanisms (for instance, a door opening signal sent from a switch that detects the opening or closing of a front door of the main body 200, a remaining toner amount detection signal sent by the developing device 207 of the image forming unit 33, or an error occurrence signal sent by an error detection mechanism, not shown, when the error detection mechanism detects an operation error in a unit of the multifunction machine 1 during operation of the latter). Examples of the detected operation states include, for instance, fax reception in progress, job execution in progress, error occurrence (paper jam in the paper transport path that joins the paper feeding cassettes 201 and the discharge tray 210, or in the document transport unit 603 of the document feeding unit 600, or abnormal stop caused, for instance, by malfunction of the image forming unit 33 or the transfer unit 34), front door open in the main body 200, toner level low, progress of post-processing by a finisher, and the like.

The proxy server 5213 provides internet connection by being interposed between a web browser 5221 and an internet network. The proxy server 5213 is connected to internet by Ethernet™ or the like.

The display control unit 522 comprises the web browser 5221 and a panel application 5222.

The web browser (web browser function unit) 5221 executes the necessary processing for displaying internet web pages on the display unit 410.

The panel application 5222 executes the necessary processing for displaying, on the display unit 410, operation guidance of the multifunction machine 1 as well as operation states of the multifunction machine 1 as detected by the operation state detection unit 5212. The panel application 5222 reads image data corresponding to operation guidance of the multifunction machine 1 and to operation states of the multifunction machine 1 as detected by the operation state detection unit 5212, from the display image data storage unit 53, and displays the read image data on the display unit 410. The panel application 5222 displays the image data corresponding to the various operation states in a status area, pre-defined as a display area of the operation states, on the display unit 410. The web browser 5221 displays a web page in an area of the display unit 410 outside the status area.

The display control device according to an embodiment of the present invention comprises, for instance, the control unit 50 and the display unit 410.

In the above example, the control section 52 comprises the main controller unit 521 comprising a CPU, and a display control unit 522 comprising an ASIC, while the display image data storage unit 53 is provided separately. However, the embodiment is not limited thereto. For instance, the display control program according to an embodiment of the present invention may be stored in the HDD 74, and the control section 52 comprising a CPU and the like may operate, in accordance with the display control program, to function as operation control unit 5211, the operation state detection unit 5212, the proxy server 5213, the web browser 5221, the panel application 5222 and the display image data storage unit 53. The display control program is provided to the user stored in a computer-readable recording medium, and is storable in the HDD 74.

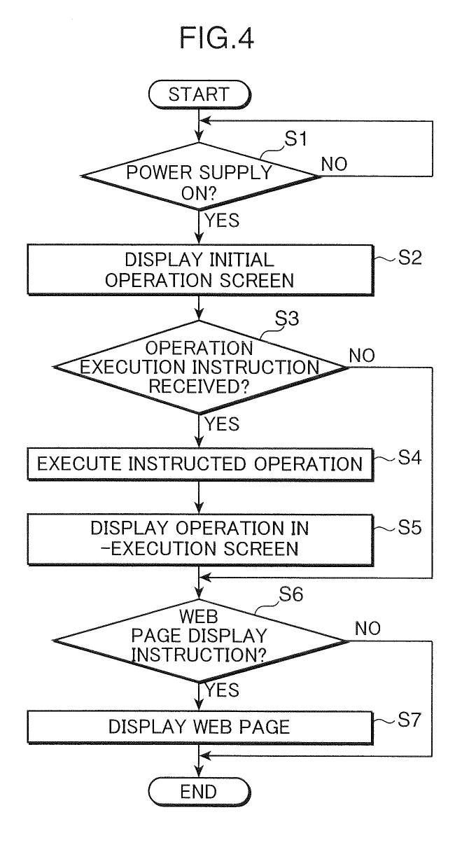

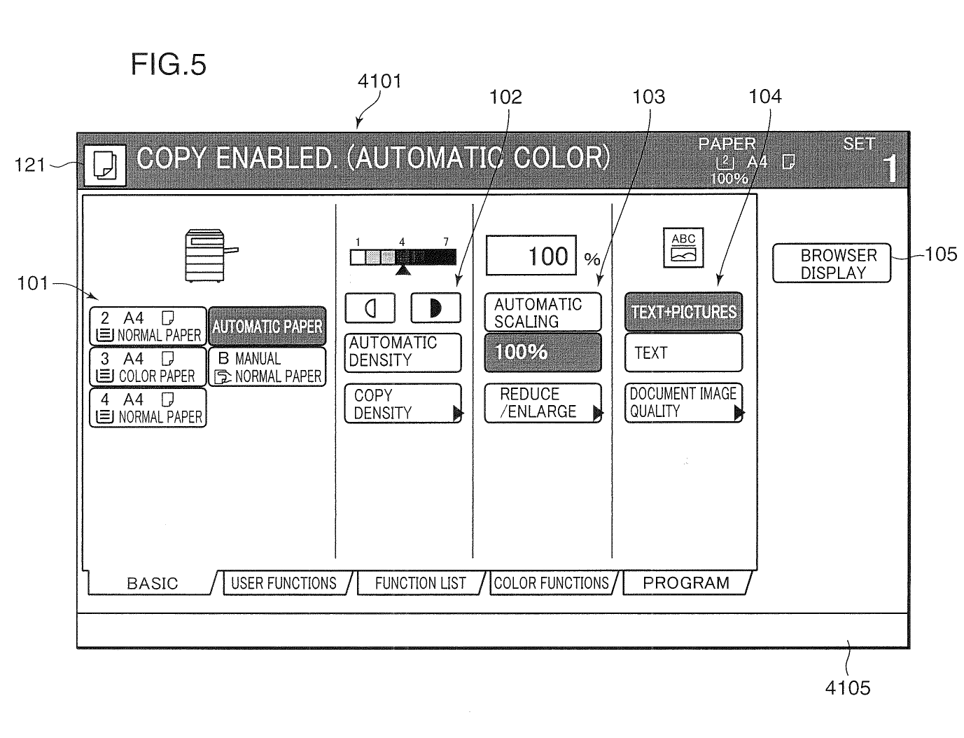

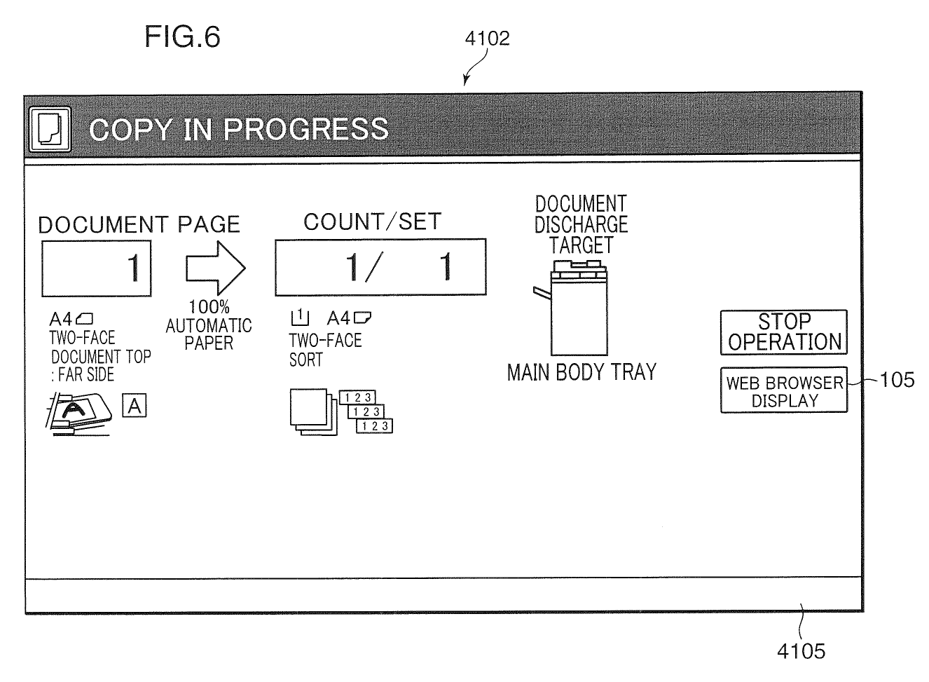

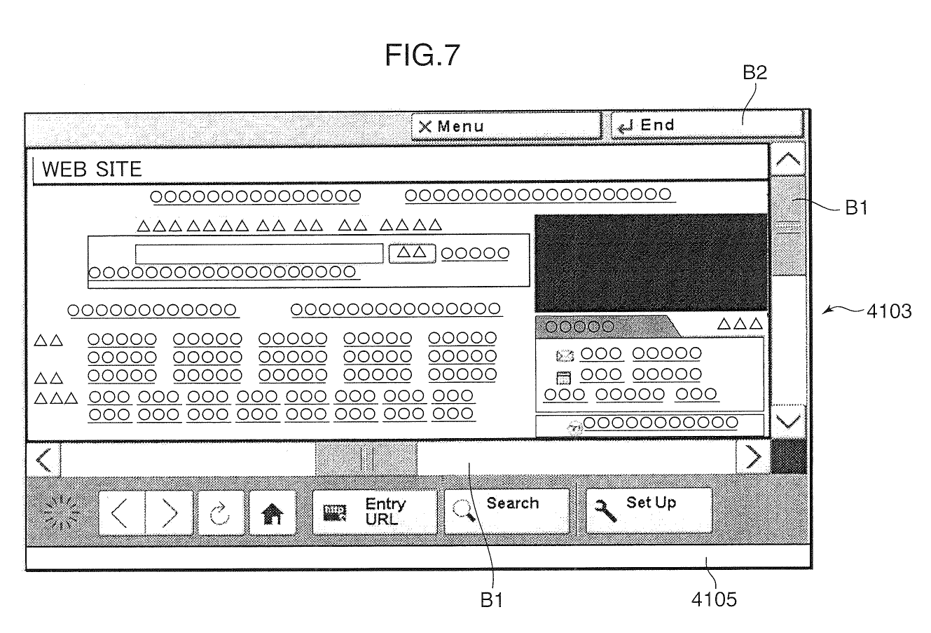

An explanation follows next on display control by the display unit 410 in the multifunction machine 1. FIG. 4 is a flowchart illustrating display control by the display unit 410 in the multifunction machine 1. FIG. 5 is a diagram illustrating an example of an initial operation screen. FIG. 6 is a diagram illustrating an example of a screen depicting a copy operation in execution. FIG. 7 is a diagram illustrating an example of a web page display screen.

When the user turns on the main power source of the multifunction machine 1 to start using the multifunction machine 1 (YES in S1), the panel application 5222 reads image data corresponding to the initial operation screen from the display image data storage unit 53 and displays an initial screen 4101, such as the one illustrated in FIG. 5, on the display unit 410 (S2). At this time, the panel application 5222 displays the initial screen 4101 in an area outside a status area 4105. The operation unit 400 is shaped so as to be capable of receiving various operation execution instructions (copy operation execution instruction, webpage display instruction or the like) from the user. As illustrated in FIG. 5, the initial screen 4101 displays, for instance, keys 101 to 104 that receive various settings during, for instance, a copy operation, and displays a browser key 105 that receives from the user a web browser launching instruction (instruction of displaying a pre-set web page on the display unit 410 upon launching of the web browser). The web browser 5221 and the operation control unit 5211 receive instructions inputted by the user through the touch panel function of the initial screen 4101 and the keys displayed on the various screens below.

When the user operates the operation unit 400 to input some operation execution instruction, for instance a copy operation execution instruction, and the instruction is received by the operation unit 400 (YES in S3), the operation control unit 5211 executes the instructed operation, in this case a copy operation (S4). Thereupon, the panel application 5222 reads image data corresponding to the screen displaying the copy operation in progress, from the display image data storage unit 53, and displays a copy operation in-progress screen 4102, such as the one illustrated in FIG. 6 (example of a screen depicting an operation in execution), on the display unit 410 (S5). The panel application 5222 displays the copy operation in-progress screen 4102 in an area outside the status area 4105. The browser key 105 is also displayed on the copy operation in-progress screen 4102. When the operation unit 400 receives no execution instruction from the user (NO in S3), the processes of S4 and S5 are skipped.

When the user presses the browser key 105 in the initial screen 4101 or the copy operation in-progress screen 4102 and a web page display instruction is received by the operation unit 400 (YES in S6), the web browser 5221 accesses, via the proxy server 5213, a web site of the web page pre-set as the first page during browser display. The web browser 5221 acquires, from the web site, image data of the web page that constitutes the first page, and displays a webpage display screen 4103, for instance such as the one illustrated in FIG. 7, on the display unit 410 (S7). Specifically, the web browser 5221 substitutes the webpage display screen 4103 for the initial screen 4101 or copy operation in-progress screen 4102 being displayed on the display unit 410 by the panel application 5222. Herein, the web browser 5221 displays the webpage display screen 4103 in an area outside the status area 4105.

To make it easier for the user to input a web page scroll instruction, a close web page instruction or the like in the webpage display screen 4103, by way of the touch panel function, the sizes of a scroll bar B1 and of a screen close button B2 are set so as to be easily touchable by the user's fingers.

When the operation unit 400 does not receive a web page display instruction from the user (NO in S6), the process of S7 is skipped.

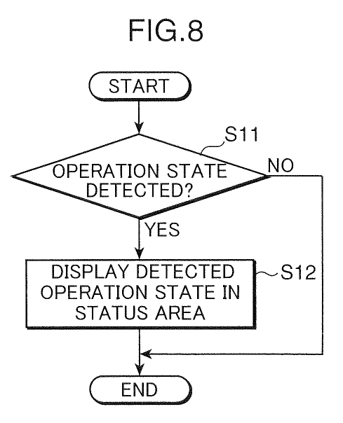

An explanation follows next on a first embodiment of a process for displaying operation states of the multifunction machine 1 in the status area 4105. FIG. 8 is a flowchart illustrating a first embodiment of a process for displaying operation states of the multifunction machine 1 in a status area.

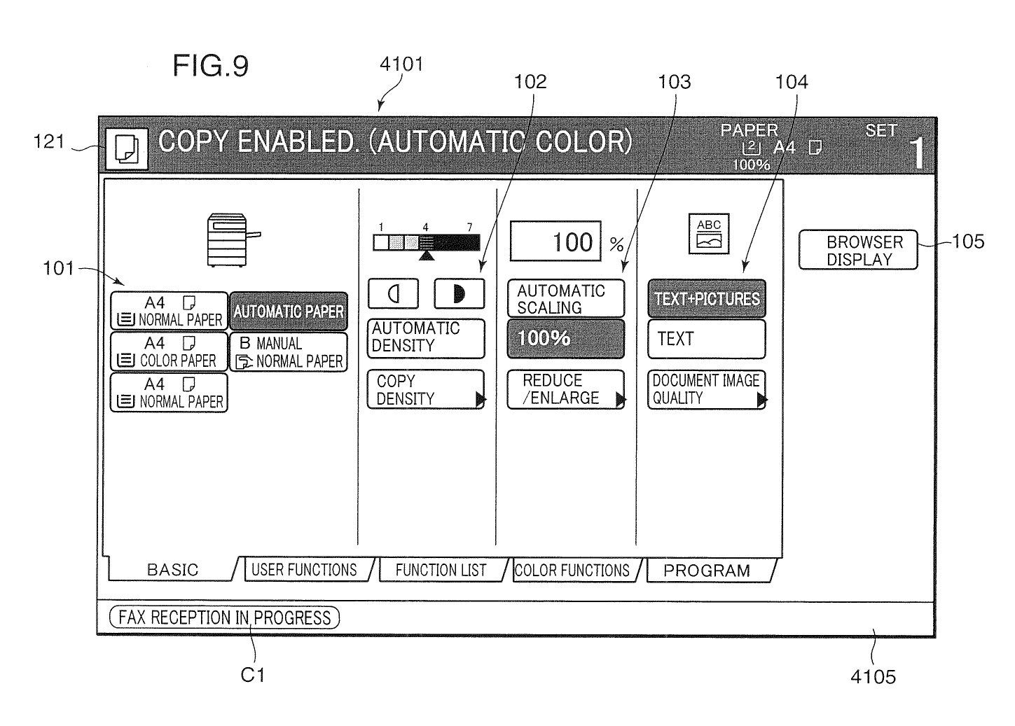

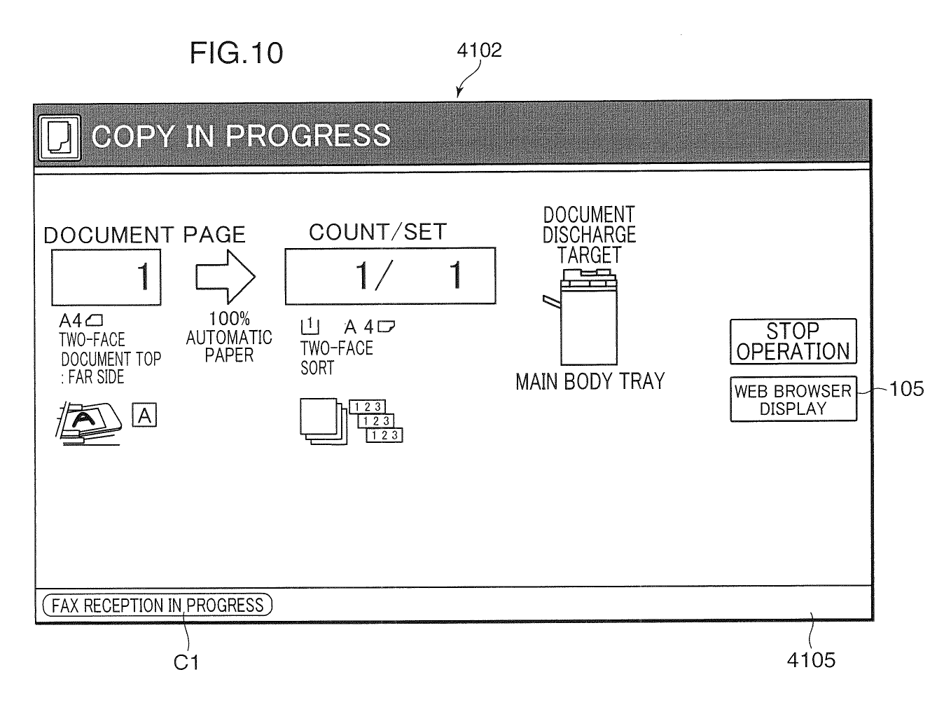

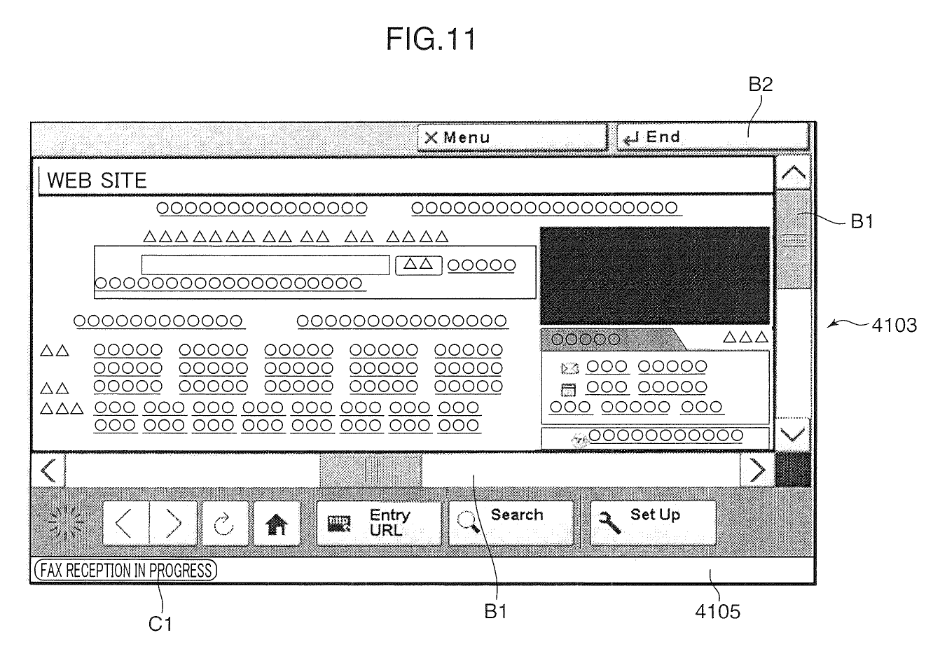

After start-up of the multifunction machine 1, the operation state detection unit 5212 detects continuously the operation state of the various units of the multifunction machine 1. When the panel application 5222 is displaying, for instance, the initial screen 4101 or the copy operation in-progress screen 4102, or when the web browser 5221 is displaying the webpage display screen 4103 on the display unit 410, and the operation state detection unit 5212 detects an above-described operation state (YES in S11), the panel application 5222 reads, from the display image data storage unit 53, image data corresponding to the operation state detected by the operation state detection unit 5212. When, for instance, the operation of fax reception in progress is being detected, the panel application 5222 displays an image C1, corresponding to the operation of fax reception in progress, in the status area 4105 of the initial screen 4101, the copy operation in-progress screen 4102 or the webpage display screen 4103, as illustrated in FIGS. 9 to 11 (S12).

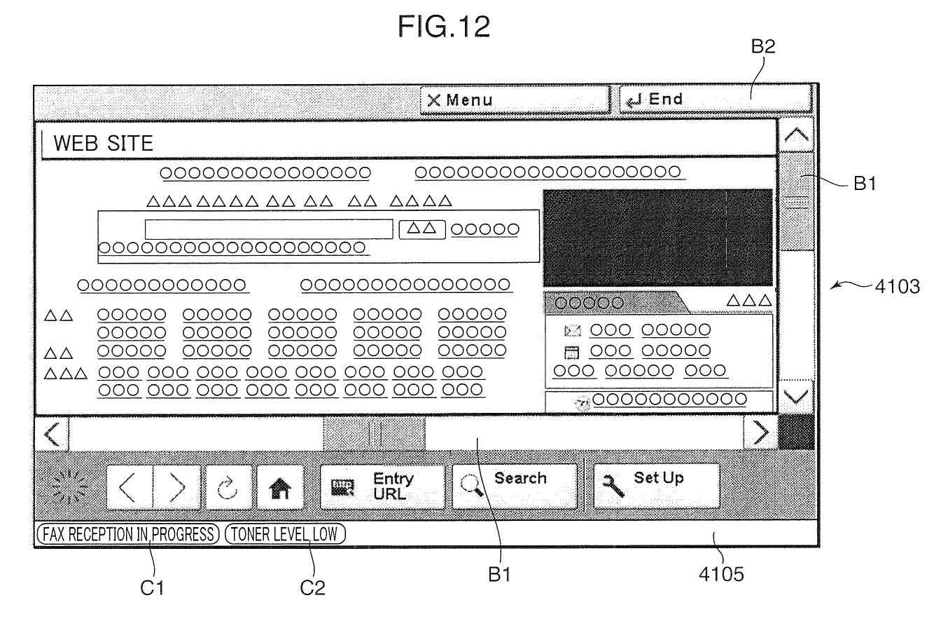

In case of plural operation states being detected by the operation state detection unit 5212, the panel application 5222 reads, from the display image data storage unit 53, image data corresponding to this plurality of operation states, and displays images C1, C2, denoting respective operation states to be displayed, side by side, within the status area 4105, as illustrated in FIG. 12.

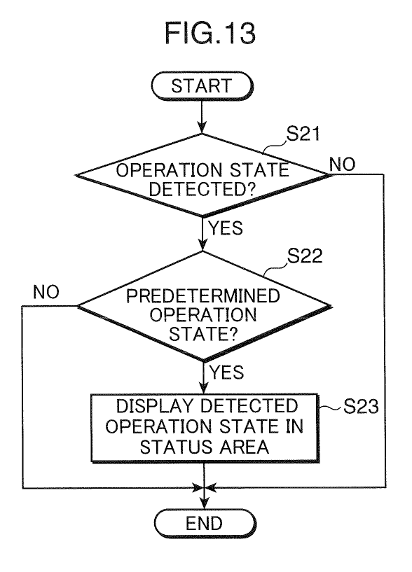

An explanation follows next on a second embodiment of a process for displaying operation states of the multifunction machine 1 in the status area 4105. FIG. 13 is a flowchart illustrating a second embodiment of a process for displaying operation states of the multifunction machine 1 in a status area. Processing identical to that of the first embodiment will not be explained again.

When in the second embodiment an above-described operation state is detected by the operation state detection unit 5212 (YES in S21), the panel application 5222 determines whether the detected operation state, as the operation state displayed on the status area, is a predetermined operation state (S22). The panel application 5222 has stored therein information on various operation states (predetermined operation states) that are displayed in the status area 4105. On the basis of that information, the panel application 5222 determines whether the detected operation state is one of the predetermined operation states, and displays an image corresponding to the detected operation state in the status area 4105 only when the detected operation state is one of the predetermined operation states (S23).

For instance, operation states that must be notified immediately to the user, as an operation state in the status area 4105 (such as paper jam occurrence, toner level low, front door of the main body 200 open and the like) are stored in the panel application 5222. Operation states that do not call for immediate notification (for instance, fax reception in progress and the like) are not stored in the panel application 5222. It becomes possible as a result to display efficiently useful operation state information in the status area 4105, which has a limited surface area outside the display areas used by, for instance, the initial screen 4101 and the webpage display screen 4103.

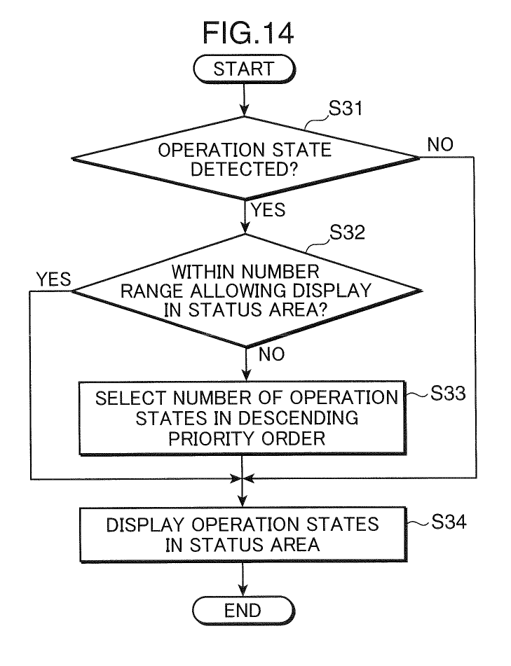

An explanation follows next on a third embodiment of a process for displaying operation states of the multifunction machine 1 in the status area 4105. FIG. 14 is a flowchart illustrating a third embodiment of a process for displaying operation states of the multifunction machine 1 in a status area. Processing identical to that of the first and second embodiments will not be explained again.

When in the third embodiment an above-described operation state is detected by the operation state detection unit 5212 (YES in S31), the panel application 5222 determines whether the number of operation states detected at that time lies within a number range that allows display in the status area 4105 (S32). Specifically, the panel application 5222 stores information on the maximum number of images, denoting an operation state, that can be displayed in the status area 4105. On the basis of that maximum number information, the panel application 5222 determines whether the number of detected operation states lies within a number range that allows display in the status area 4105.

When in S32 the panel application 5222 determines that the number of detected operation states lies within a number range that allows display in the status area 4105 (YES in S32), the panel application 5222 reads image data corresponding to all the detected operation states, from the display image data storage unit 53, and displays the images depicting the respective operation states in the status area 4105 (S34).

On the other hand, when in S32 the panel application 5222 determines that the number of detected operation states does not lie within a number range that allows display in the status area 4105 (NO in S32), the panel application 5222 extracts the maximum number of operation states that can be displayed in the status area 4105, in order of descending priority, on the basis of priority order information stored beforehand (S33), and displays these operation states in the status area 4105 (S34).

For instance, the panel application 5222 stores information on the priority order of display in the status area 4105 for the operation states of the multifunction machine 1 that are to be notified to the user immediately, in descending order of necessity (operation states of high notification urgency may include, for instance, front door of main body 200 open, as a first state, paper jam occurrence as a second state, toner level low as a third state, and so forth, whereas operation states of little notification urgency may include, for instance, fax reception in progress, as a last-priority state). The panel application 5222 selects the number of operation states that can be displayed on the basis of the above-described priority order.

It becomes possible thereby to display as many truly useful operation states as possible in a narrow status area 4105 having a limited surface area.

When in the third embodiment the number of detected operation states does not lie within a number range that allows display in the status area 4105, the panel application 5222 selects the maximum number of operation states that can be displayed in the status area 4105 on the basis of the above-described priority order, and displays the selected number of operation states in the status area 4105. Instead of this, however, the panel application 5222 may read, from the display image data storage unit 53, only image data corresponding to the operation state having the highest priority order, on the basis of the above-described priority order, when the detected operation states are more than one, so that the panel application 5222 displays in the status area 4105 only image data depicting this highest-priority operation state.

The present invention is not limited to the above embodiments and may accommodate various modifications. In the above embodiments, for instance, the panel application 5222 and the web browser 5221 display the initial screen 4101 and so forth, or the webpage display screen 4103, in an area outside the status area 4105. In the above embodiments, furthermore, the initial screen 4101 and so forth or the webpage display screen 4103 may be displayed over the entire display screen of the display unit 410 until an operation state is detected by the operation state detection unit 5212, and at the moment when the operation state is detected by the operation state detection unit 5212 the panel application 5222 and the web browser 5221 cause the display area of the initial screen 4101 and so forth, or of the webpage display screen 4103, to shrink to the area outside the status area 4105.

In the above embodiments, FIGS. 1 to 14 illustrate embodiments of the display control device, image forming apparatus and display control program according to the present invention. These are however merely illustrative of examples of the present invention, and are not meant in any way to limit the configurations, processes and so forth of the present invention.

Essentially, the present invention is a display control apparatus including: a display unit that displays an image; a web browser function unit that causes the display unit to display a web page; an operation state detection unit that detects an operation state of electric equipment to which the display control apparatus is provided; and a state display control unit that causes the display unit to display in a status area thereof which is predetermined as a display area of the operation state an operation state detected by the operation state detection unit, wherein the web browser function unit causes the display unit to display in an area thereof outside a status area the web page.

Also, the present invention is a computer-readable medium which stores a display control program for causing a computer, built into a display control apparatus, to function as a web browser function unit that causes a display unit of the display control apparatus to display a web page; an operation state detection unit that detects an operation state of electric device to which the display control apparatus is provided; and a state display control unit that causes the display unit to display in a status area thereof which is predetermined as a display area of the operation state an operation state detected by the operation state detection unit, wherein the web browser function unit causes the display unit to display in an area outside a status area thereof the web page.

In these inventions, when a web page is displayed by the web browser function unit on the display unit of the electric equipment, the web browser function unit displays the web page in an area outside a status area in which an operation state of the electric equipment is displayed by the state display control unit. Therefore, this allows securing a display area, on the screen of the display unit, for the operation state that is to be displayed, in order to improve the operability of the electric equipment, while ensuring at the same time visibility of the web page to the user. As a result, the inventions allow securing web page visibility to the user, without detracting from the operability of the electric equipment, for instance an image forming apparatus, when a web page is displayed on a display unit provided in the electric equipment.

In the present invention, furthermore, the web browser function unit causes the display unit to display over the entire area of a display screen of the display unit the web page until the operation state detection unit detects the operation state, and reduces the display area of the web page to an area outside the status area when the operation state detection unit detects an operation state.

The invention allows enhancing operability and visibility for the user by increasing the web page display surface area through display of the web page across the entire screen of the display unit, while enabling an operation state of the electric equipment to be displayed on the display unit when a operation state of the electric equipment is detected, to enhance thereby the operability of the image forming apparatus by the user.

In the present invention, furthermore, the state display control unit displays, in the status area, only a predetermined operation state from among the operation states detected by the operation state detection unit.

The display unit provided in the electric equipment, for instance an image forming apparatus, is not the large screen of a personal computer but a comparatively small screen. This limits the surface area of the web page display area and of the status area on which the operation states of the electric equipment are displayed. However, useful operation state information can be accurately displayed in a narrow status area of limited surface area by displaying in the status area only a predetermined operation state from among the operation states detected by the operation state detection unit, as is the case in the present invention.

In the present invention, furthermore, the state display control unit holds a priority order, according to which the predetermined operation states are preferentially displayed in the status area, such that the state display control unit induces a display, in the status area, of an operation state having high priority order when the operation state detection unit detects a plurality of the predetermined operation states.

When the operation state detection unit detects a plurality of the predetermined operation states, the state display control unit displays in the status area a high-priority order operation state, as is the case in the present invention. This allows extracting and displaying truly useful operation state information, from among a plurality of detected operation states, in a narrow status area having a limited surface area.

In the present invention, furthermore, the state display control unit stores a maximum number of the operation states that can be displayed in the status area, such that when the operation state detection unit detects operation states exceeding that number, the state display control unit selects the number of operation states in descending order according to the priority order to be displayed in the status area.

In the invention, when the operation state detection unit detects a plurality of operation states, the state display control unit selects and displays, in the status area, a number of operation states that can be displayed in the status area, in descending priority order. Therefore, it becomes possible to display as many truly useful operation states as possible in a narrow status area having a limited surface area.

In the present invention, furthermore, the state display control unit holds a priority order, according to which the predetermined operation states are preferentially displayed in the status area, such that the state display control unit induces a display, in the status area, of an operation state having high priority order when the operation state detection unit detects a plurality of the predetermined operation states, and wherein the state display control unit stores a maximum number of the operation states that can be displayed in the status area, such that when the operation state detection unit detects operation states exceeding that number, the state display control unit selects the number of operation states in descending order according to the priority order to be displayed in the status area.

The invention allows improving operability and visibility of a web page for the user while further increasing operability of the electric equipment by the user, when an operation state must be displayed on the display screen, by securing a status area and by selecting and displaying a truly useful operation state in this limited status area.

The present invention is also an image forming apparatus as the electric device, including: a recording unit that records an image on recording paper on the basis of data to be printed; and any of the display control apparatus above.

This application is based on Japanese Patent application serial No. 2008-235427 filed in Japan Patent Office on Sep. 12, 2008, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A display control apparatus, comprising:
a display unit that displays an image;
a web browser function unit that causes the display unit to display a web page;
an operation state detection unit that detects an operation state of electric equipment to which the display control apparatus is provided; and
a state display control unit that causes the display unit to display in a status area thereof which is predetermined as a display area of the operation state an operation state detected by the operation state detection unit, wherein
the web browser function unit causes the display unit to display in an area thereof outside a status area the web page.

2. The display control apparatus according to claim 1, wherein
the web browser function unit causes the display unit to display over the entire area of a display screen of the display unit the web page until the operation state detection unit detects the operation state, and reduces the display area of the web page to an area outside the status area when the operation state detection unit detects an operation state.

3. The display control apparatus according to claim 1, wherein the state display control unit displays, in the status area, only a predetermined operation state from among the operation states detected by the operation state detection unit.

4. The display control apparatus according to claim 3, wherein
the state display control unit holds a priority order, according to which the predetermined operation states are preferentially displayed in the status area, such that the state display control unit induces a display, in the status area, of an operation state having high priority order when the operation state detection unit detects a plurality of the predetermined operation states.

5. The display control apparatus according to claim 4, wherein
the state display control unit stores a maximum number of the operation states that can be displayed in the status area, such that when the operation state detection unit detects operation states exceeding that number, the state display control unit selects the number of operation states in descending order according to the priority order to be displayed in the status area.

6. The display control apparatus according to claim 2, wherein
the state display control unit holds a priority order, according to which the predetermined operation states are preferentially displayed in the status area, such that the state display control unit induces a display, in the status area, of an operation state having high priority order when the operation state detection unit detects a plurality of the predetermined operation states, and wherein
the state display control unit stores a maximum number of the operation states that can be displayed in the status area, such that when the operation state detection unit detects operation states exceeding that number, the state display control unit selects the number of operation states in descending order according to the priority order to be displayed in the status area.

7. An image forming apparatus, as an electric device, comprising:
a recording unit that records an image on recording paper on the basis of data to be printed; and
the display control apparatus according to claim 1.

8. A computer-readable medium which stores a display control program for causing a computer, built into a display control apparatus, to function as
a web browser function unit that causes a display unit of the display control apparatus to display a web page;
an operation state detection unit that detects an operation state of electric device to which the display control apparatus is provided; and
a state display control unit that causes the display unit to display in a status area thereof which is predetermined as a display area of the operation state an operation state detected by the operation state detection unit, wherein
the web browser function unit causes the display unit to display in an area outside a status area thereof the web page.
